(19) United States
(12) Patent Application Publication
(10) Pub. No.: US 2012/0093394 A1
(43) Pub. Date: Apr. 19, 2012

(54) METHOD FOR COMBINING DUAL-LENS IMAGES INTO MONO-LENS IMAGE

(75) Inventor: Yun-Chin Li, Taipei County (TW)

(73) Assignee: ALTEK CORPORATION, Hsinchu City (TW)

(21) Appl. No.: 13/029,139

(22) Filed: Feb. 17, 2011

(30) Foreign Application Priority Data
Oct. 13, 2010 (TW) 99134923

(51) Int. Cl. G06K 9/36

(52) U.S. Cl. 382/154

(57) ABSTRACT

A method for combining dual-lens images into a mono-lens image, suitable for a three-dimensional camera having a left lens and a right lens is provided. First, the left lens and the right lens are used to capture a left-eye image and a right-eye image. Next, a disparity between each of a plurality of corresponding pixels in the left-eye image and the right-eye image is calculated. Then, an overlap area of the left-eye image and the right-eye image is determined according to the calculated disparities of pixels. Finally, the images within the overlap area of the left-eye image and the right-eye image are combined into the mono-lens image.

### CROSS-REFERENCE TO RELATED APPLICATION

This application claims the priority benefit of Taiwan application serial no. 99134923, filed on Oct. 13, 2010. The entirety of the above-mentioned patent application is hereby incorporated by reference herein and made a part of this specification.

### BACKGROUND

1. Field of the Invention

The invention relates to an image processing method. Particularly, the invention relates to a method for combining dual-lens images into a mono-lens image.

2. Description of Related Art

A three-dimensional (3D) camera is formed by dual lenses of a same specification, and a distance between the dual lenses is about 7.7 cm, so as to simulate an actual distance between human eyes. Parameters such as a focal length, an aperture, a shutter of the dual lenses are controlled by a processor of the 3D camera, and images of different fields of vision (FOVs) can be captured by triggering a shutter release, and these images are used for simulating images viewed of a left eye and a right eye of a viewer.

The left-eye image and the right-eye image captured by the 3D camera are alternately displayed on a display device in a frequency higher than a visual persistence frequency of human eyes, and in collaboration with a switching operation of liquid crystal shutter glasses, the left eye and the right eye of the viewer can view corresponding left-eye and right-eye images. After the left-eye and right-eye images are transmitted to cerebral cortex of the viewer, a cerebral cortex center combines the left-eye and right-eye images into a single object image. Since the left-eye and right-eye images are slightly different in viewing angles, the object images formed on retinas have a certain parallax, and the cerebral cortex center can combine the object images of different viewing angles in two eyes to produce a 3D effect.

Since the 3D camera may produce two images each time, and a special display device is required to play the images to produce the 3D effect, in case that user's devices do not support the 3D effect or photos are required to be developed, the left-eye and right-eye images are required to be converted into a mono-lens image for outputting. In this case, according to a processing method of a general 3D camera, one of the left-eye and right-eye images is selected for outputting.

However, since FOVs of the images captured by the 3D camera and the mono-lens camera are different, the presented contents are different, especially in case of a close-up shot, a difference of the FOVs of the captured images is more obvious, which may result in a difference between the FOV of the output image of the 3D camera and the FOV actually observed by the viewer.

### SUMMARY OF THE INVENTION

The invention is directed to a method for combining dual-lens images into a mono-lens image, by which the mono-lens image with a normal field of vision (FOV) can be provided.

The invention provides a method for combining dual-lens images into a mono-lens image, which is adapted to a three-dimensional camera having a left lens and a right lens. In the method, the left lens and the right lens are respectively used to capture a left-eye image and a right-eye image. Next, a disparity of each of a plurality of corresponding pixels in the left-eye image and the right-eye image is calculated. Then, an overlap area of the left-eye image and the right-eye image is determined according to the calculated disparities of the pixels. Finally, the left-eye image and the right-eye image are combined into the mono-lens image according to images within the overlap area.

In an embodiment of the invention, the step of combining the images within the overlap area of the left-eye image and the right-eye image into the mono-lens image comprises enlarging a combined image within the overlap area of the left-eye image and the right-eye image to an original size of the left-eye image and the right-eye image to serve as the mono-lens image.

In an embodiment of the invention, the step of combining the images within the overlap area of the left-eye image and the right-eye image into the mono-lens image comprises selecting the image within the overlap area of the left-eye image or the right-eye image to serve as the mono-lens image.

In an embodiment of the invention, the step of combining the images within the overlap area of the left-eye image and the right-eye image into the mono-lens image comprises capturing at least one characteristic of the images within the overlap area of the left-eye image and the right-eye image, and combining the images within the overlap area of the left-eye image and the right-eye image into an overlap area image according to the at least one characteristic to serve as the mono-lens image.

In an embodiment of the invention, the step of calculating the disparity of each of the corresponding pixels in the left-eye image and the right-eye image comprises calculating a displacement of each of the corresponding pixels in the left-eye image and the right-eye image according to a position of each of the corresponding pixels in the left-eye image and the right-eye image to serve as the disparity.

The invention provides a method for combining dual-lens images into a mono-lens image, which is adapted to a three-dimensional camera having a left lens and a right lens. In the method, the left lens and the right lens are respectively used to capture a left-eye image and a right-eye image. Then, a disparity of each of a plurality of corresponding pixels in the left-eye image and the right-eye image is calculated. Then, an overlap area and a non-overlap area of the left-eye image and the right-eye image are determined according to the calculated disparities of the pixels. Finally, a part of image (for example, a right half image) within the non-overlap area of the left-eye image, images within the overlap area of the left-eye image and the right-eye image and a part of image (for example, a left half image) within the non-overlap area of the right-eye image are combined into the mono-lens image.

In an embodiment of the invention, the step of combining the part of image within the non-overlap area of the left-eye image, the images within the overlap area of the left-eye image and the right-eye image and the part of image within the non-overlap area of the right-eye image into the mono-lens image comprises selecting the image within the overlap area of the left-eye image or the right-eye image to combine with a right half image within the non-overlap area of the left-eye image and a left half image within the non-overlap area of the right-eye image to serve as the mono-lens image.

In an embodiment of the invention, the step of selecting the image within the overlap area of the left-eye image or the right-eye image to combine with the right half image within the non-overlap area of the left-eye image and the left half image within the non-overlap area of the right-eye image to serve as the mono-lens image comprises capturing at least one characteristic of the images within the overlap area of the left-eye image and the right-eye image, and combining the images within the overlap area of the left-eye image and the right-eye image into an overlap area image according to the at least one characteristic, and combining the right half image within the non-overlap area of the left-eye image, the overlap area image and the left half image within the non-overlap area of the right-eye image to serve as the mono-lens image.

In an embodiment of the invention, the step of selecting the image within the overlap area of the left-eye image or the right-eye image to combine with the right half image within the non-overlap area of the left-eye image and the left half image within the non-overlap area of the right-eye image to serve as the mono-lens image comprises sequentially combining the right half image, the images in the overlap area and the left half image from left to right to serve as the mono-lens image.

According to the above descriptions, in the method for combining dual-lens images into the mono-lens image, by calculating the disparity of each of the corresponding pixels in the left-eye image and the right-eye image captured by the dual lenses, the overlap area and the non-overlap areas of the left-eye image and the right-eye image are determined. According to a characteristic that a normal FOV is in the middle of a left lens FOV and a right lens FOV, the images within the overlap area of the left-eye image and the right-eye image are combined, or the image within the overlap area of the left-eye image or the right-eye image and a part of the images within the non-overlap areas are combined to output the mono-lens image having the normal FOV.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an example of using a three-dimensional (3D) camera to capture an image according to an embodiment of the invention.

FIG. 2 is a block diagram illustrating a device for combining dual-lens images into a mono-lens image.

FIG. 3 is a flowchart illustrating a method for combining dual-lens images into a mono-lens image according to an embodiment of the invention.

FIG. 4 is a flowchart illustrating a method for combining dual-lens images into a mono-lens image according to an embodiment of the invention.

### DETAILED DESCRIPTION OF DISCLOSED EMBODIMENTS

Since fields of vision (FOVs) of a left-eye image and a right-eye image captured by a three-dimensional (3D) camera are different, contents of the left-eye image and the right-eye image are different. However, a part of areas in the left-eye image and the right-eye image are still overlapped, and image content in the overlapped area is image content of an image captured by a mono-lens camera at a same position. Therefore, in the invention, the overlap area and non-overlap areas of the left-eye image and the right-eye image are estimated according to disparity information between the left-eye image and the right-eye image captured by the 3D camera. Accordingly, the images within the overlap area of the left-eye image and the right-eye image are combined, or the image within the overlap area and a part of the images within the non-overlap areas are combined to produce a mono-lens image having the normal FOV.

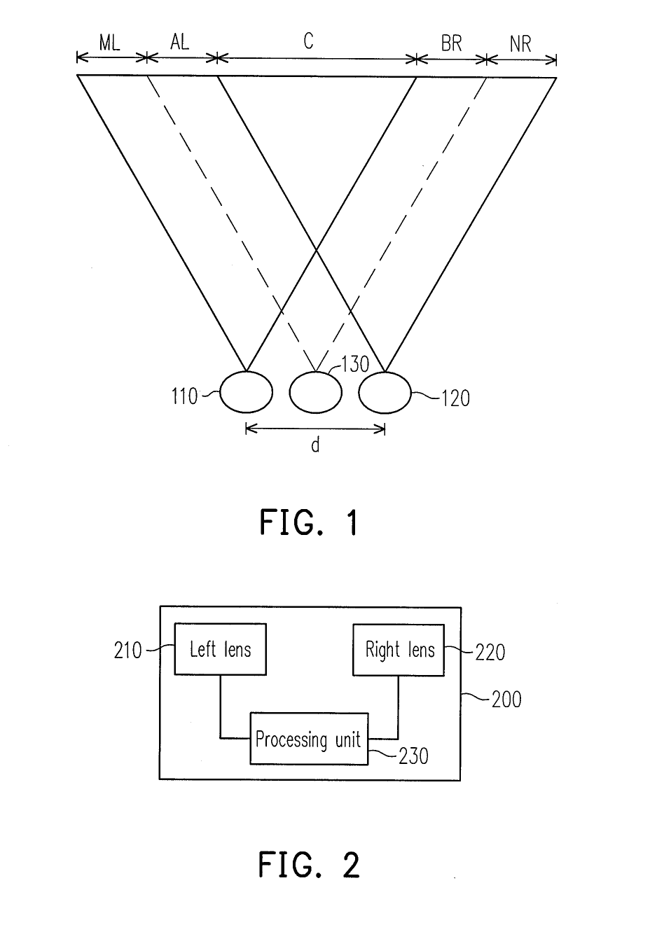

In detail, FIG. 1 is an example of using a 3D camera to capture an image according to an embodiment of the invention. Referring to FIG. 1, the 3D camera of the present embodiment includes a left lens 110 and a right lens 120 with a spacing distance of d. Both of the left lens 110 and the right lens 120 have a fixed FOV, and the FOVs thereof are intersected in an overlap area C. Assuming a lens 130 of a general mono-lens camera is placed in the middle of the left lens 110 and the right lens 120, a FOV of the lens 130 may cover a portion of FOVs of the left-eye image and the right-eye image. According to a proportion relation of FIG. 1, it is known that the lens 130 is placed in the middle of the left lens 110 and the right lens 120, and a left edge of the FOV of the lens 130 is also located in the middle of left edges of the FOVs of the left lens 110 and the right lens 120, so that sizes of an area ML and an area AL are the same. Similarly, a right edge of the FOV of the lens 130 is also located in the middle of right edges of the FOVs of the left lens 110 and the right lens 120, so that sizes of an area BR and an area NR are the same.

The invention provides a method for combining dual-lens images into a mono-lens image according to the above principle. FIG. 2 is a block diagram illustrating a device for combining dual-lens images into a mono-lens image. Referring to FIG. 2, the device 200 of the present embodiment is, for example, a 3D camera, which includes a left lens 210, a right lens 220 and a processing unit 230.

Both of the left lens 210 and the right lens 220 have light sensing devices (not shown) for respectively sensing intensity of light entering the left lens 210 and the right lens 220, so as to produce a left-eye image and a right-eye image. The light sensing device is, for example, a charge coupled device (CCD), a complementary metal-oxide semiconductor (CMOS) device or other devices, which is not limited by the invention. Moreover, a lens space of about 77 mm is formed between the left lens 210 and the right lens 220, so as to simulate an actual distance between human eyes.

The processing unit 230 is, for example, a central processing unit (CPU) or a programmable microprocessors, a digital signal processor (DSP), a programmable controller, an application specific integrated circuit (ASIC), a programmable logic device (PLD) or other similar devices, which is coupled to the left lens 210 and the right lens 220 for combining the left-eye image and the right-eye image captured by the left lens 210 and the right lens 220, so as to output the mono-lens image.

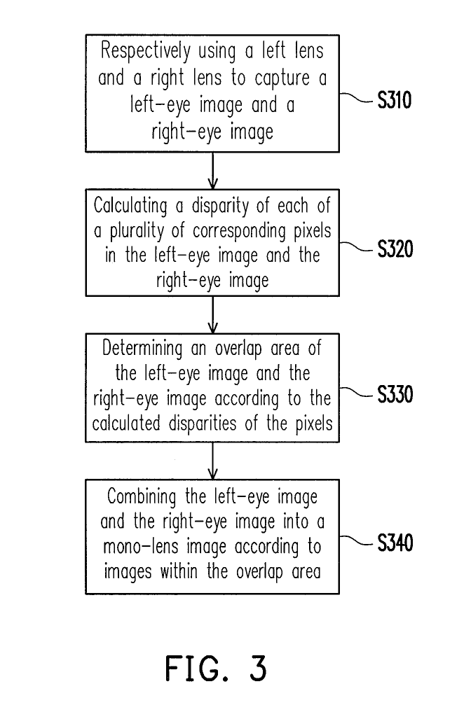

In detail, FIG. 3 is a flowchart illustrating a method for combining dual-lens images into a mono-lens image according to an embodiment of the invention. Referring to FIG. 2 and FIG. 3, the method of the present embodiment is adapted to the device 200 of FIG. 2, and is adapted to output the mono-lens image with a normal FOV when a user uses the device 200 to capture an image. Detailed steps of the method of the present embodiment are described below with reference of various devices of the device 200 of FIG. 2.

First, the left lens 210 and the right lens 220 are respectively used to capture a left-eye image and a right-eye image (step S310). The left lens 210 and the right lens 220, for example, use same parameters to capture the images, and the parameters includes a focal length, an aperture, a shutter, a white balance, etc., which is not limited by the invention.

Then, the processing unit 230 calculates a disparity of each of a plurality of corresponding pixels in the left-eye image and the right-eye image (step S320). In detail, in the present embodiment, the pixel is taken as a unit to calculate the disparity, and a method thereof is to calculate a displacement of a pixel in the left-eye image and the right-eye image according to a position of such pixel in the left-eye image and the right-eye image to serve as the disparity.

Then, the processing unit 230 determines an overlap area of the left-eye image and the right-eye image according to the calculated disparities of the pixels (step S330). According to FIG. 1, it is known that the corresponding pixels in the left-eye image and the right-eye image are in the overlap area of the left-eye image and the right-eye image, so that a position of the overlap area can be determined according to the disparities calculated by the processing unit 230.

Finally, the processing unit 230 combines the left-eye image and the right-eye image into the mono-lens image according to images within the overlap area (step S340). The processing unit 230, for example, combines the images within the overlap area of the left-eye image and the right-eye image into the mono-lens image. In detail, the images within the overlap area of the left-eye image and the right-eye image are slightly different due to different shooting angles of the left lens 210 and the right lens 220, though in case that a distance between the 3D camera 200 and a shooting object is relatively large, the above difference can be neglected. Therefore, the processing unit 230 can automatically select or the user can select the image within the overlap area of the left-eye image or the right-eye to serve as the final output mono-lens image.

On the other hand, in case that the distance between the 3D camera 200 and the shooting object is relatively close, the difference of the images within the overlap area of the left-eye image and the right-eye is obvious. Now, the processing unit 230 may capture at least one characteristic of the images within the overlap area of the left-eye image and the right-eye image according to an image processing method, so as to combine the images within the overlap area of the left-eye image and the right-eye image into an overlap area image to serve as the final output mono-lens image.

It should be noticed that since a size of the overlap area image combined by the 3D camera 200 is smaller than an original size of the left-eye image or the right-eye image, in the present embodiment, the processing unit 230 further enlarges the size of the combined image to the original size of the left-eye image or the right-eye image to serve as the final output mono-lens image. In this way, the user can view the image with a standard size and normal FOV.

On the other hand, in case that the user wants to obtain the mono-lens image of the standard size without enlarging the image to influence its resolution, the invention provides another implementation to combine a part of images of non-overlap areas of the left-eye image and the right-eye image and the overlap area image, so as to produce the mono-lens image with a size the same as the original size. Another embodiment is provided below for description.

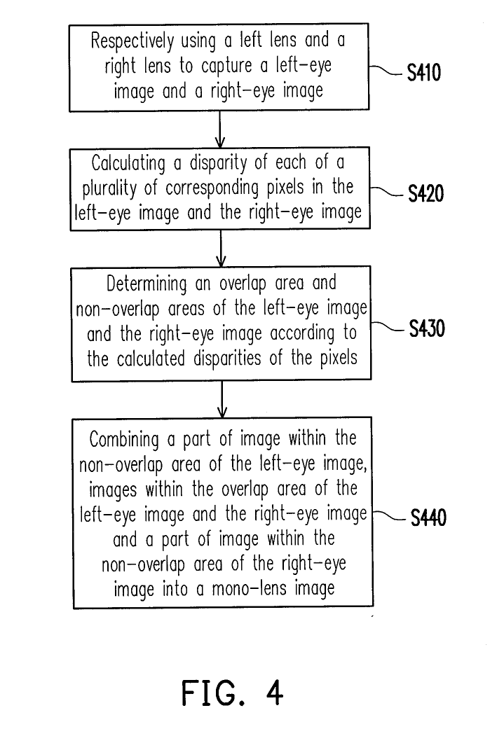

FIG. 4 is a flowchart illustrating a method for combining dual-lens images into a mono-lens image according to an embodiment of the invention. Referring to FIG. 2 and FIG. 4, the method of the present embodiment is adapted to the device 200 of FIG. 2, and is adapted to output the mono-lens image with a normal FOV when a user uses the device 200 to capture an image. Detailed steps of the method of the present embodiment are described below with reference of various devices of the device 200 of FIG. 2.

First, the left lens 210 and the right lens 220 are respectively used to capture a left-eye image and a right-eye image (step S410). Then, the processing unit 230 calculates a disparity of each of a plurality of corresponding pixels in the left-eye image and the right-eye image (step S420). The steps S410-S420 are the same as or similar to that of the steps S310-S320 of the aforementioned embodiment, so that detailed descriptions thereof are not repeated herein.

Different from the aforementioned embodiment, in the present embodiment, after the processing unit 330 calculates the disparities of the pixels, an overlap area and non-overlap areas of the left-eye image and the right-eye image are determined according to the calculated disparity information (step S430). Taking FIG. 1 as an example, the processing unit 330 can determine the overlap area C and the non-overlap area (i.e. the area ML plus the area AL) of the left-eye image according to the disparities of the pixels. Similarly, the processing unit 330 can also determine the overlap area C and the non-overlap area (i.e. the area BR plus the area NR) of the right-eye image.

Finally, the processing unit 230 combines a part of image (for example, a right half image) within the non-overlap area of the left-eye image, images within the overlap area of the left-eye image and the right-eye image and a part of image (for example, a left half image) within the non-overlap area of the right-eye image into the mono-lens image (step S440). Taking FIG. 1 as an example, the processing unit 230 sequentially combines the image of the area AL in the left-eye image, the images in the overlap area C of the left-eye image and the right-eye image and the image of the area BR in the right-eye image from left to right, so as to obtain the mono-lens image with the standard size and normal FOV.

It should be noticed that in the above step of combining the images within the overlap area of the left-eye image and the right-eye image, similar to the method of the aforementioned embodiment, the image within the overlap area of only one of the left-eye image and the right-eye image can be selected for combination, or the characteristics of the images within the overlap area of the left-eye image and the right-eye image can be captured for combining the images within the overlap area of the left-eye image and the right-eye image into an overlap area image for combination, which is not limited by the invention.

In summary, in the method for combining dual-lens images into the mono-lens image, the overlap area and the non-overlap areas of the left-eye image and the right-eye image captured by the 3D camera are determined, and the images of the overlap area are directly combined, or combined with a part of images of the non-overlap areas, so as to produce the mono-lens image having the normal FOV.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for combining dual-lens images into a mono-lens image, adapted to a three-dimensional camera having a left lens and a right lens, the method comprising:
respectively using the left lens and the right lens to capture a left-eye image and a right-eye image;
calculating a disparity of each of a plurality of corresponding pixels in the left-eye image and the right-eye image;
determining an overlap area of the left-eye image and the right-eye image according to the calculated disparities of the pixels; and
combining the left-eye image and the right-eye image into the mono-lens image according to images within the overlap area.

2. The method for combining dual-lens images into the mono-lens image as claimed in claim 1, wherein the step of combining the left-eye image and the right-eye image into the mono-lens image according to the images within the overlap area comprises:
combining the images within the overlap area of the left-eye image and the right-eye image into the mono-lens image.

3. The method for combining dual-lens images into the mono-lens image as claimed in claim 2, wherein the step of combining the images within the overlap area of the left-eye image and the right-eye image into the mono-lens image comprises:
enlarging a combined image within the overlap area of the left-eye image and the right-eye image to an original size of the left-eye image and the right-eye image to serve as the mono-lens image.

4. The method for combining dual-lens images into the mono-lens image as claimed in claim 2, wherein the step of combining the images within the overlap area of the left-eye image and the right-eye image into the mono-lens image comprises:
selecting the image within the overlap area of the left-eye image or the right-eye image to serve as the mono-lens image.

5. The method for combining dual-lens images into the mono-lens image as claimed in claim 1, wherein the step of combining the left-eye image and the right-eye image into the mono-lens image according to the images within the overlap area comprises:
capturing at least one characteristic of the images within the overlap area of the left-eye image and the right-eye image; and
combining the images within the overlap area of the left-eye image and the right-eye image into an overlap area image according to the at least one characteristic to serve as the mono-lens image.

6. The method for combining dual-lens images into the mono-lens image as claimed in claim 1, wherein the step of calculating the disparity of each of the corresponding pixels in the left-eye image and the right-eye image comprises:
calculating a displacement of each of the corresponding pixels in the left-eye image and the right-eye image according to a position of each of the corresponding pixels in the left-eye image and the right-eye image to serve as the disparity.

7. A method for combining dual-lens images into a mono-lens image, adapted to a three-dimensional camera having a left lens and a right lens, the method for combining dual-lens images into the mono-lens image comprising:
respectively using the left lens and the right lens to capture a left-eye image and a right-eye image;
calculating a disparity of each of a plurality of corresponding pixels in the left-eye image and the right-eye image;
determining an overlap area and a non-overlap area of the left-eye image and the right-eye image according to the calculated disparities of the pixels; and
combining a part of image within the non-overlap area of the left-eye image, images within the overlap area of the left-eye image and the right-eye image and a part of image within the non-overlap area of the right-eye image into the mono-lens image.

8. The method for combining dual-lens images into the mono-lens image as claimed in claim 7, wherein the step of combining the part of image within the non-overlap area of the left-eye image, the images within the overlap area of the left-eye image and the right-eye image and the part of image within the non-overlap area of the right-eye image into the mono-lens image comprises:
selecting the image within the overlap area of the left-eye image or the right-eye image to combine with a right half image within the non-overlap area of the left-eye image and a left half image within the non-overlap area of the right-eye image to serve as the mono-lens image.

9. The method for combining dual-lens images into the mono-lens image as claimed in claim 8, wherein the step of selecting to combine the image within the overlap area of the left-eye image or the right-eye image, the right half image within the non-overlap area of the left-eye image and the left half image within the non-overlap area of the right-eye image to serve as the mono-lens image comprises:
capturing at least one characteristic of the images within the overlap area of the left-eye image and the right-eye image;
combining the images within the overlap area of the left-eye image and the right-eye image into an overlap area image according to the at least one characteristic; and
combining the right half image within the non-overlap area of the left-eye image, the overlap area image and the left half image within the non-overlap area of the right-eye image to serve as the mono-lens image.

10. The method for combining dual-lens images into the mono-lens image as claimed in claim 7, wherein the step of calculating the disparity of each of the corresponding pixels in the left-eye image and the right-eye image comprises:
calculating a displacement of each of the corresponding pixels in the left-eye image and the right-eye image according to a position of each of the corresponding pixels in the left-eye image and the right-eye image to serve as the disparity.

11. The method for combining dual-lens images into the mono-lens image as claimed in claim 8, wherein the step of selecting the image within the overlap area of the left-eye image or the right-eye image to combine with the right half image within the non-overlap area of the left-eye image and the left half image within the non-overlap area of the right-eye image to serve as the mono-lens image comprises:
sequentially combining the right half image, the image in the overlap area and the left half image from left to right to serve as the mono-lens image.
